(19) United States
(12) Patent Application Publication
(10) Pub. No.: US 2008/0047583 A1
(43) Pub. Date: Feb. 28, 2008

(54) Substrate Processing Method and Apparatus

(76) Inventors: Akira Fukunaga, Tokyo (JP); Akira Susaki, Tokyo (JP); Junko Mine, Tokyo (JP); Xinming Wang, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/794,809

(22) PCT Filed: Dec. 28, 2005
(86) PCT No.: PCT/JP05/24277

§ 371 Date: Jul. 6, 2007

(30) Foreign Application Priority Data
Jan. 6, 2005 (JP) 2005-001836

(51) Int. Cl. C23G 1/02; B08B 3/08

(52) U.S. Cl. 134/3; 134/105; 134/19

(57) ABSTRACT

A substrate processing method can form highly-reliable interconnects with little current leakage between interconnects without causing significant damage to the interconnects. The substrate processing method comprises heating and reacting a contaminant on a substrate with a carboxylic acid in an atmosphere containing the carboxylic acid, thereby removing the contaminant.

### TECHNICAL FIELD

The present invention relates to a substrate processing method and apparatus for cleaning a surface of a substrate such as a semiconductor wafer, for example, in the production of a semiconductor device, and more particularly to a substrate processing method and apparatus useful for filling fine interconnect recesses, provided in a surface of a substrate such as a semiconductor wafer, with an interconnect material (metal) such as copper to form interconnects, or for selectively covering surfaces of interconnects with a protective metal film to protect the interconnects.

### BACKGROUND ART

In recent year, instead of using aluminum or an aluminum alloy as an interconnect material for forming interconnect circuits on a substrate, such as a semiconductor wafer, there is an eminent movement toward using copper (Cu) which has a low electric resistivity and high electromigration resistance. Copper interconnects are generally formed by filling fine interconnect recesses, provided in a surface of a substrate, with copper. Known methods for forming such copper interconnects include CVD, sputtering and plating. In any such method, a copper film is formed in almost an entire surface of a substrate, followed by removal of unnecessary copper by chemical-mechanical polishing (CMP).

In the 45 nm-node or later generation, in particular, mainly for the purpose of further enhancing the electromigration resistance of copper interconnects, for example, it is considered necessary to selectively cover exposed surfaces of copper interconnects with a protective metal film of e.g. a CoWP alloy to protect the interconnects. When forming a protective metal film by electroless plating, it is necessary to bring a substrate surface into contact with liquid chemicals, such as a plating solution containing metal ions in a high concentration and an organic component, a cleaning solution containing an organic component, etc. This involves the formation of a complex between an organic component of the liquid chemical and an interconnect material, increasing the risk of metal contamination or organic compound contamination due to defects, such as residues of the complex.

FIGS. 1A through 2 illustrate an example of a process for forming copper interconnects in a semiconductor device. First, as shown in FIG. 1A, an etch stopper film 12 is formed on a lower-layer insulating film 10, and an upper-layer insulating film (interlevel dielectric film) 14, for example, an oxide film of SiO₂ or a film of a low-k material, is deposited on a surface of the etch stopper film 12. Interconnect trenches 16 as interconnect recesses are formed in the upper-layer insulating film 14, for example, by the lithography/etching technique. Thereafter, a barrier film 18 of Ta, TaN, or the like is formed on a surface of the upper-layer insulating film 14 and, as necessary, a seed layer (not shown), which serves as an electric supply layer for electroplating, is formed on a surface of the barrier film 18, for example, by sputtering, thereby preparing a substrate W (step 1).

Next, as shown in FIG. 1B, copper plating of the surface of the substrate W is carried out to fill the interconnect trenches 16 with copper and, at the same time, deposit a copper film 20 on the upper-layer insulating film 14 (step 2). Thereafter, the barrier film 18 and the copper film 20 on the upper-layer insulating film 14 are removed, for example, by chemical-mechanical polishing (CMP) so as to make the surface of the copper film 20, embedded in the interconnect trenches 16, substantially flush with the surface of the upper-layer insulating film 14 (step 3). Interconnects (copper interconnects) 22 composed of the copper film 20 are thus formed in the upper-layer insulating film 14, as shown in FIG. 1C. The surface of the substrate W is then cleaned, and rinsed (water-washed) e.g. with pure water, followed by drying such as spin-drying (step 4).

FIGS. 3A through 4 illustrate an example of a process for forming a protective metal film of a CoWP alloy on the thus-formed interconnects 22 to protect the interconnects 22. First, a substrate W shown in FIG. 1C, having the interconnects (copper interconnects) 22 formed in the upper-layer insulating film 14 and dried, is provided (step 1). The surface of the substrate W is subjected to pre-plating processing to apply Pd as a catalyst selectively to the surfaces of interconnects 22 (step 2). The pre-plating processing is necessary because of difficulty in directly carrying out plating on the interconnects 22 of copper. This processing is carried out, for example, by bringing the substrate surface into contact with a solution of palladium sulfate.

Next, the surface of the substrate W is brought into contact with an electroless plating solution to form a protective metal film 24 of e.g. a CoWP alloy, which grows on Pd seed, selectively on the surfaces of interconnects 22 to protect the interconnects 22, as shown in FIG. 3A (step 3). A thickness of the protective metal film 24 is, for example, about 10 nm.

Next, as shown in FIG. 3B, the substrate W is subjected to post-plating processing using, for example, a roll brush 26 to increase the selectively of the protective metal film 24 (step 4). In particular, for example, scrub cleaning is carried out by mechanically rubbing the surface of the substrate W with the roll brush 26 while supplying pure water to the surface of the substrate W, thereby removing residues, etc. remaining on the surface of the substrate W, as shown in FIG. 3C. Other known post-cleaning methods include a method in which a substrate surface is mechanically rubbed with a rotating pencil-shaped brush to remove residues, etc. from the substrate surface, a method in which pressure waves are applied to a substrate surface by a megasonic generator to remove residues, etc. from the substrate surface, and a method in which residues, etc. on a substrate surface is etched away with an organic acid solution. After the pre-plating processing, the surface of the substrate W is rinsed (water-washed) e.g. with pure water, followed by drying such as spin-drying (step 5).

Various post-cleaning methods have been proposed, among which are a method in which a copper oxide on copper interconnects is etched away by using glacial acetic acid in the manufacturing of a semiconductor device (see, for example, K. L. Chanez and D. W. Hess, Journal of the Electrochemical Society, Vol. 148, No. 11, G640-643 (2001)), a method in which a processing object is exposed to a gas containing acetic acid in order to clean a copper surface at the bottom of a fine hole and clean side walls of the hole, and to also clean a surface of an interlevel dielectric film (see, for example, Japanese Patent Laid-Open Publication No. 2001-271192), and a method in which an oxide film on surfaces of copper interconnects is subjected to a reduction treatment with formic acid vapor (see, for example, Japanese Patent No. 3373499).

### DISCLOSURE OF INVENTION

As interconnects become finer, the possibility of device failure due to current leakage from interconnects is becoming higher. Especially when a strongly hydrophobic low-k material is employed for the insulating film (interlevel dielectric film) 14 shown in FIG. 1A, after polishing away the unnecessary interconnect material (copper film) e.g. by CMP to form interconnects 22, the strongly hydrophobic insulating film 14 of low-k material becomes exposed, together with the hydrophilic interconnects (copper) 22, on the surface of the substrate W, as shown in FIG. 1C. Accordingly, upon drying of the substrate W following its water-washing (rinsing), uniform drying cannot be effected and water marks are likely to be created on the substrate surface after water-washing and drying. When a residue 28 of copper after polishing remains unremoved on the surface of the insulating film 14, as shown in FIG. 1C, the residue 28 is likely to cause current leakage between interconnects. This is because the interconnect material is slightly dissolved in rinse water whereby upon evaporation of the rinse water, the substrate surface becomes highly contaminated with the metal in the water-mark portions.

An organic component of a liquid chemical used in polishing of an interconnect material can form a complex with the interconnect material. Defects, such as residues of the complex, can cause current leakage between interconnects and failures in the next processing. A decrease in the number of defects is therefore required especially in the 65 nm-node or later generation. In particular, a polishing chemical for use in polishing generally contains organic components as additives which are employed in view of differences in properties, such as hardness, between an interconnect material such as copper and a barrier film such as of Ta. Examples of such organic components include an organic agent for preferentially polishing a barrier film while protecting an interconnect material, and an organic anticorrosive such as persistent BTA (benzotriazole). Accordingly, even after cleaning a substrate with pure water or a liquid chemical, a small amount of an organic complex, formed between polished copper and an organic component of a polishing chemical, will remain on interconnects or an insulating film. Further, water marks are likely to be created on a substrate surface after CMP especially when a low-k material is used for an interlevel dielectric film, which may result in increased current leakage between interconnects. This is because an interconnect material is slightly dissolved in rinse water and an organic complex is formed whereby upon evaporation of the rinse water, the substrate surface becomes highly contaminated with the organic compound in the water-mark portions.

In the selective formation of the protective metal film 24 of CoWP alloy on the surfaces of interconnects 22, if a copper residue 28 remains on the surface of the insulating film 14 after polishing e.g. by CMP, as shown in FIG. 1C, Pd adheres to the residue 28 and a CoWP alloy deposits as a residue 30 on the surface of the insulating film 14. Further, with a Pd residue remaining unremoved on the insulating film 14 as a seed, a CoWP alloy likewise deposits on the insulating film 14 and becomes a residue 30.

Similarly, when an organic complex between polished copper and an organic component of a liquid chemical remains as a residue on the surface of the interconnects 22 or the surface of the insulating film 14, Pd adheres to the organic complex residue and a CoWP alloy deposits as a residue 30 on the surface of the interconnects 22 or the surface of the insulating film 14.

It is generally difficult to completely remove such a residue 30 from the substrate surface. Applying a large physical force to the residue 30 in order to remove it mechanically will cause damage to the substrate. If an acid having a strong etching power is used in order to etch away the residue 30, interconnects can also be corroded with the chemical, leading to an increase in the resistance of the interconnects. Further, also upon water-washing (rinsing) and drying of the substrate after post-cleaning, water marks will be created on the substrate surface as upon water-washing (rinsing) and drying after CMP.

At any rate, if a conductive material, such as copper, a CoWP alloy or a salt or an organic compound thereof, remains unremoved and exists as a residue on an insulating film, nonnegligible current leakage can occur between interconnects and, in addition, an interconnect material such as copper can diffuse into the insulating film, resulting in a significant loss of the reliability of the interconnect device.

The present invention has been made in view of the above situation in the background art. It is therefore an object of the present invention to provide a substrate processing method and apparatus which can form highly-reliable interconnects with little current leakage between interconnects without causing significant damage to the interconnects.

In order to achieve the above object, the present invention provides a substrate processing method comprising heating and reacting a contaminant on a substrate with a carboxylic acid in an atmosphere containing the carboxylic acid, thereby removing the contaminant.

The carboxylic acid may be supplied through its vaporization by heating or bubbling of an inert gas into the carboxylic acid.

For example, when Cu (OH)₂ as a metal contaminant is heated and reacted with acetic acid in an atmosphere containing acetic acid, Cu(CH₃COO)₂ is produced and the Cu(CH₃COO)₂ vaporizes at the vapor pressure. By thus removing a metal contaminant from a surface of a substrate, e.g. through volatilization, leakage current between interconnects can be decreased. This holds also for an organic compound contaminant remaining on a surface of a substrate. Further, by carrying out the removal of a metal contaminant and/or an organic compound contaminant by a so-called dry method which involves no electrochemical corrosion, damage to interconnects can be reduced and the formation of an oxide film. e.g. on the surface of the interconnects, due to insufficient drying of the substrate after cleaning, can be prevented. The vaporization of the carboxylic acid is effected by, for example, vaporization under reduced pressure, vaporization by heating, or bubbling of an inert gas into the carboxylic acid.

The present invention also provides another substrate processing method comprising: providing a substrate which has been prepared by forming a barrier film on a surface of a substrate having interconnect recesses formed in an insulating film, and forming a film of an interconnect material on a surface of the barrier film while filling the interconnect recesses with the interconnect material; removing an extra interconnect material and an extra barrier film from the surface to thereby form interconnects composed of the interconnect material embedded in the interconnect recesses; and heating and reacting a contaminant on the substrate with a carboxylic acid in an atmosphere containing the carboxylic acid, thereby removing the contaminant.

After the formation of interconnects in a surface of a substrate, an interconnect material which can be present on an insulating film between the interconnects, or a complex between an interconnect material and an organic component of a liquid chemical is likely to cause metal contamination or organic compound contamination of the substrate surface e.g. upon cleaning. As interconnects become finer and the spacing between interconnects becomes increasingly smaller, the risk of current leakage due to metal contamination or organic compound contamination becomes higher. Further, when a low-k material is employed for an insulating film, a hydrophilic portion and a hydrophobic portion are co-present in a surface of a substrate after the formation of interconnects. This makes uniform drying of the surface of the substrate difficult upon its spin-drying after rinsing.

According to the present invention, leakage current can be decreased and damage to interconnects can be reduced in a surface of a substrate even under such conditions by removing a metal contaminant and/or an organic compound contaminant, such as an interconnect material or its compound, present on an insulating film between interconnects in the surface of the substrate after the formation of the interconnects.

The present invention also provides yet another substrate processing method comprising: providing a substrate having interconnects formed of an interconnect material embedded in interconnect recesses provided in an insulating film; forming a protective metal film selectively on surfaces of interconnects; and heating and reacting a contaminant on the substrate with a carboxylic acid in an atmosphere containing the carboxylic acid, thereby removing the contaminant.

By thus removing a metal contaminant present on an insulating film between interconnects or an organic compound contaminant after the selective formation of a protective metal film of e.g. a CoWP alloy to protect the interconnects, e.g. through volatilization, an increase in leakage current and a rise in the resistance of the interconnects can be prevented. In addition, cleaning and drying of the surface of the substrate after the removal of the contaminant is not necessary, and therefore the oxidation of the surface of the protective metal film can be avoided.

The contaminant includes a metal contaminant, an organic compound contaminant, and a resist residue remaining on the surface of the substrate after the removal of a resist.

If a resist, which has become unnecessary after the formation of interconnect recesses in an insulating film, is removed completely, for example by chemical cleaning, moisture can enter the insulating film of e.g. a low-k material, which increases the risk of current leakage. Completely removing a resist by ashing can cause damage, such as corrosion, to interconnects or an insulating film. Such drawbacks can be avoided by removing an unnecessary resist, for example, by chemical cleaning or by ashing while leaving a resist residue, and heating and reacting the remaining resist residue with a carboxylic acid in an atmosphere containing the carboxylic acid, thereby removing the resist residue.

The removal of the interconnect material and the barrier film is preferably carried out by CMP, electrolytic polishing or a combination thereof.

In the case of carrying out the removal of the interconnect material and the barrier film by CMP, the polishing is preferably carried out at a low pressure of not more than 1 psi (about 70 hPa) in order not to cause damage to the interconnects. In the case of electrolytic polishing, the processing may be carried out either by pressing a polishing pad against the substrate surface in a polishing liquid not containing abrasive grains to flatten the substrate surface, or by pressing a polishing pad against the substrate surface in a polishing liquid containing abrasive grains to flatten the substrate surface. It is also possible to carry out the removal of the interconnect material by electrolytic polishing and carry out the subsequent removal of the barrier film by CMP.

The formation of the protective metal film is preferably carried out by electroless plating.

The protective metal film is composed of, for example, cobalt, nickel, tungsten, vanadium or molybdenum, or an alloy or a compound thereof.

A Co alloy such as a CoWP alloy or a Ni alloy such as a NiWP alloy, which has high adhesion to an interconnect material such as copper and a low resistivity (ρ), is generally used for the protective metal film.

The interconnects may include interconnects having an interconnect width of not more than 0.2 μm.

The problem of current leakage between interconnects generally occurs when the width of the interconnects is not more than 2 μm. A low-k material is advantageously used for an insulating film (interlevel dielectric film) when the width of interconnects is not more than 0.1 μm, especially about 45 to 65 nm.

The interconnect material is, for example, copper, silver, tungsten, tantalum, titanium, ruthenium, gold, tin or lead, or an alloy thereof.

Preferably, the surface of the substrate is water-washed prior to the removal of the contaminant on the substrate.

Even when water marks, which has high risk to be a metal contaminant or an organic compound contaminant, are created on a surface of a substrate after water-washing and drying of the substrate, the water marks can be removed upon the subsequent removal processing of the contaminant, e.g. through volatilization, sublimation or decomposition. Thus, the water marks, which has high risk to be a metal contaminant or an organic compound contaminant, can be prevented from remaining on the surface of the substrate.

The carboxylic acid preferably is formic acid, acetic acid or propionic acid, or a mixture thereof.

Such a carboxylic acid as formic acid, acetic acid or propionic acid is not only relatively inexpensive, but is also easy to handle because it is liquid at room temperature, and can react with a metal or an organic compound to thereby vaporize the metal or the organic compound. Accordingly, the use of a carboxylic acid, especially formic acid, acetic acid or propionic acid can remove a metal contaminant or an organic compound contaminant easily at a low cost, e.g. through volatilization, sublimation or decomposition.

The insulating film is composed of, for example, SiO₂, a low-k material or a porous low-k material.

The present invention also provides a substrate processing apparatus comprising a contaminant removal apparatus for heating and reacting a contaminant on a substrate with a carboxylic acid in an atmosphere containing the carboxylic acid, thereby removing the contaminant.

In a preferred embodiment of the present invention, the contaminant removal apparatus includes: an airtight chamber capable of vacuum evacuation, housing a substrate holder for holding a substrate and heating the substrate, and a gas supply head for supplying a gaseous carboxylic acid to the substrate held by the substrate holder; and a carboxylic acid supply system for supplying the gaseous carboxylic acid to the gas supply head.

According to this embodiment, the processing for the removal of a contaminant can be carried out in the airtight chamber by a so-called dry method which involves no electrochemical corrosion and is free from the problem of oxide film formation due to insufficient drying.

In a preferred embodiment of the present invention, the substrate processing apparatus further comprises a water-washing/drying apparatus for water-washing and drying the surface of the substrate.

In a preferred embodiment of the present invention, the substrate processing apparatus further comprises a polishing apparatus for polishing away an extra interconnect material and an extra barrier film from the surface of the substrate.

In a preferred embodiment of the present invention, the substrate processing apparatus further comprises a protective film-forming apparatus for forming a protective metal film selectively on surfaces of interconnects formed of an interconnect material embedded in interconnect recesses provided in an insulating film in the substrate surface.

According to the present invention, current leakage between interconnects can be considerably reduced, for example after the removal of an extra interconnect material and an extra barrier film e.g. by CMP or after the selective formation of a protective metal film of e.g. a CoWP alloy on the surfaces of interconnects by electroless plating. For example, it has been confirmed experimentally that when a substrate with interconnects, having an interconnect width of 0.16 μm and an interconnect spacing of 0.16 μm, formed in an insulating film in the surface, is provided and a metal contaminant on the insulating film is removed by reacting it with formic acid in an atmosphere containing the carboxylic acid, leakage current upon 2V application can be decreased to about one-tenth as compared to the case of removing the metal contaminant only by pure water-washing as conventionally practiced. In the experiment, the leakage current was determined by two-point probe measurement.

It has also been confirmed that when a substrate with interconnects, having an interconnect width of 0.25 μm and an interconnect spacing of 0.25 μm, formed in an insulating film in the surface, is provided and an organic compound contaminant on the substrate is removed by reacting it with formic acid in an atmosphere containing the carboxylic acid, leakage current upon 1 V application can be decreased to about one-tenth as compared to the case of removing the organic compound contaminant only by pure water-washing as conventionally practiced. In the experiment, the leakage current was determined by two-point probe measurement.

Further, by employing a so-called dry method which involves no electrochemical corrosion, it becomes possible to considerably reduce damage to interconnects, to prevent the formation of an oxide film on surfaces of interconnects or a surface of a protective metal film due to insufficient drying of the substrate after cleaning, and to reduce the amount of chemical used.

### BRIEF DESCRIPTION OF DRAWINGS

FIGS. 1A through 1C are diagrams illustrating an example of a conventional process for the formation of copper interconnects in a semiconductor device;

FIG. 2 is a flow chart of an example of the conventional process for the formation of copper interconnects;

FIGS. 3A through 3C are diagrams illustrating an example of a conventional process for the formation of a protective metal film in a semiconductor device;

FIG. 4 is a flow chart of an example of the conventional process for the formation of a protective metal film;

FIG. 5 is a schematic plan view of a substrate processing apparatus according to an embodiment of the present invention;

FIG. 6 is a schematic view of a contaminant removal apparatus of the substrate processing apparatus shown in FIG. 5;

FIG. 7 is a schematic plan view of a substrate processing apparatus according to another embodiment of the present invention;

FIGS. 8A through 8C are diagrams illustrating an example of a process for the formation of interconnects by the substrate processing apparatus shown in FIG. 7;

FIG. 9 is a flow chart of an example of the process for the formation of interconnects by the substrate processing apparatus shown in FIG. 7;

FIG. 10 is a schematic plan view of a substrate processing apparatus according to yet another embodiment of the present invention;

FIGS. 11A through 11C are diagrams illustrating an example of a process for the formation of a protective metal film by the substrate processing apparatus shown in FIG. 10;

FIG. 12 is a flow chart of an example of the process for the formation of a protective metal film by the substrate processing apparatus shown in FIG. 10; and

FIG. 13 is a graph showing the results of an experimental removal processing for the removal of BAT (benzotriazole).

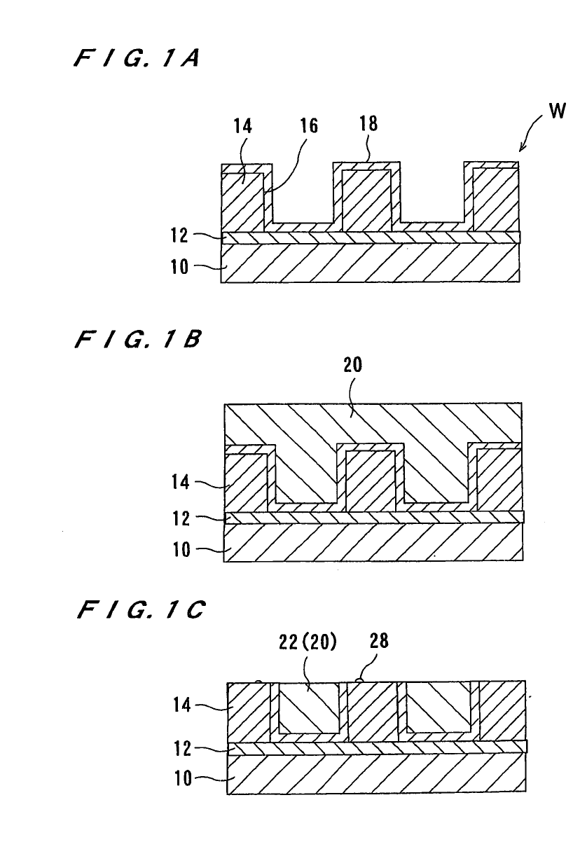

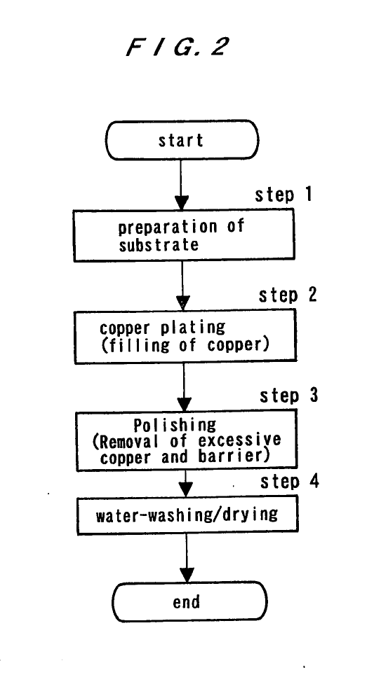

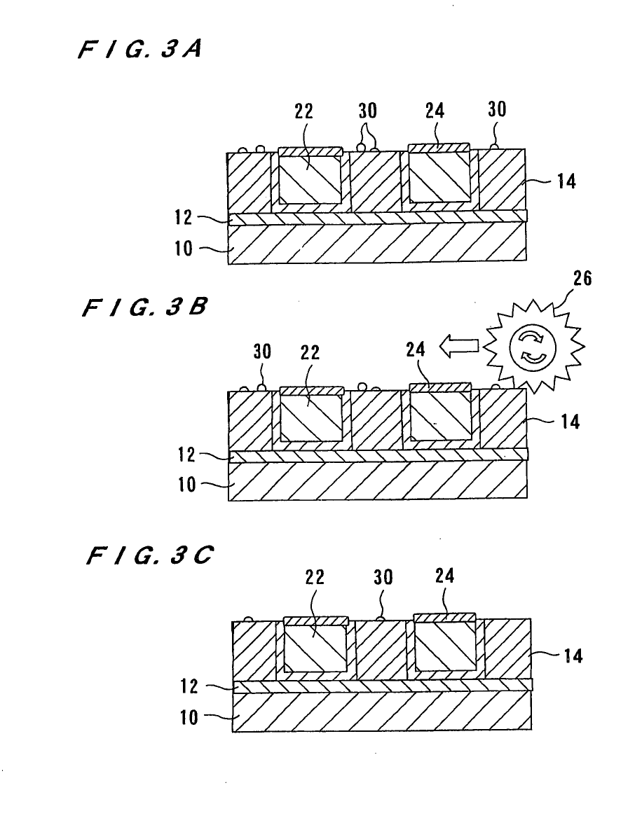

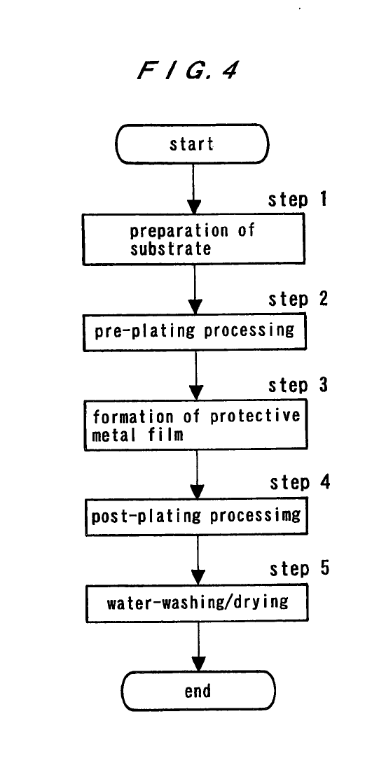

### BEST MODE FOR CARRYING OUT THE INVENTION

Preferred embodiments of the present will now be described with reference to the drawings.

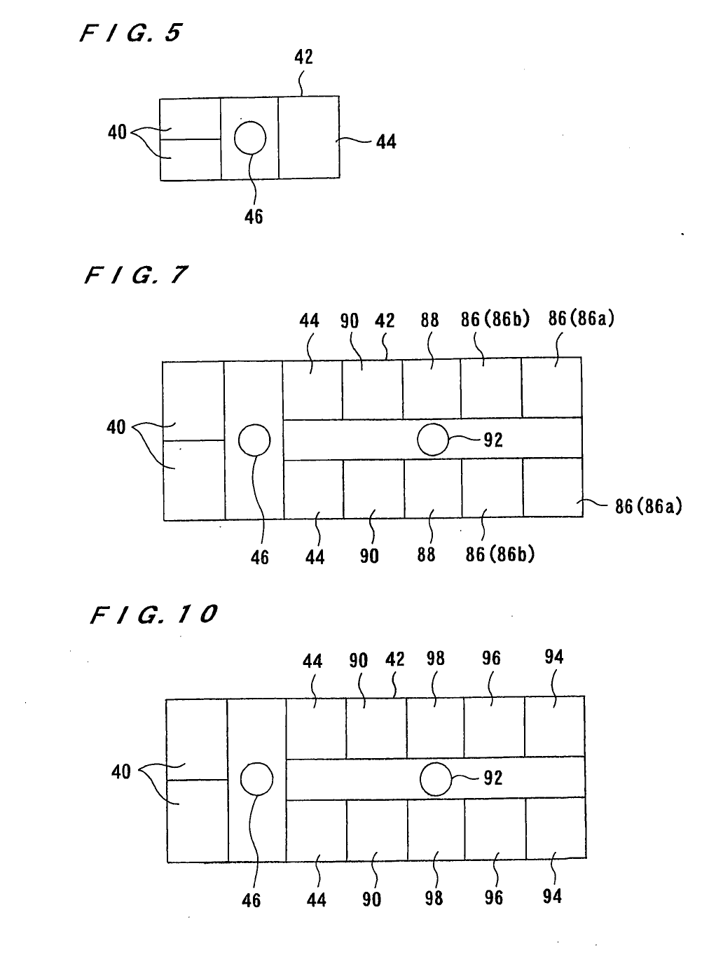

FIG. 5 shows a substrate processing apparatus according to an embodiment of the present invention. The substrate processing apparatus includes an apparatus frame 42 having a pair of loading/unloading sections 40 as a carry-in-and-out section for carrying in and out a cassette housing substrates. In the interior of the apparatus frame 42 are disposed a contaminant removal apparatus 44 and a transport robot 46 for transferring a substrate between the contaminant removal apparatus 44 and the cassette that has been carried into the loading/unloading section 40.

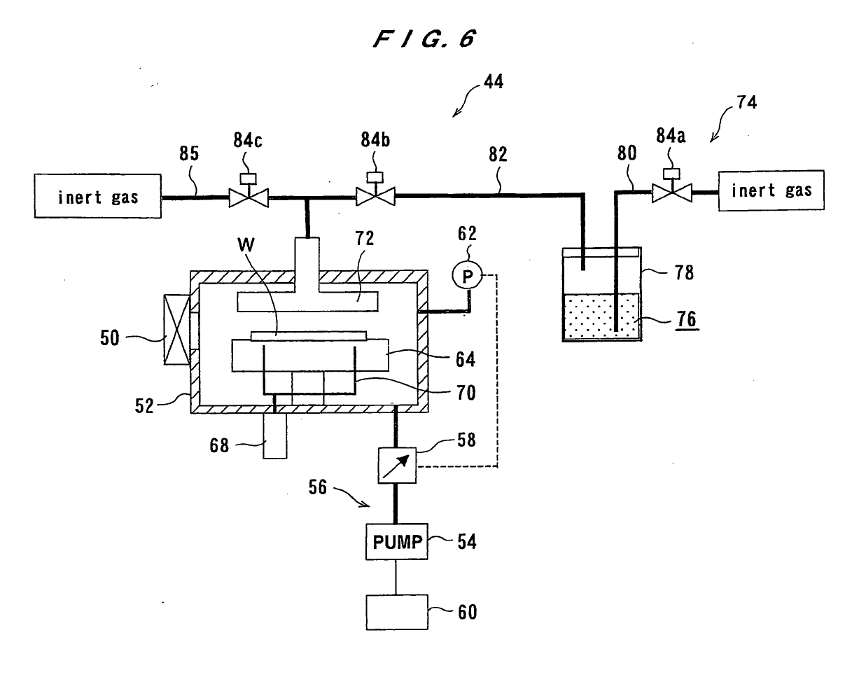

FIG. 6 shows the contaminant removal apparatus 44 provided in the substrate processing apparatus shown in FIG. 5. The contaminant removal apparatus 44 includes an airtight chamber 52 having an openable and closable gate valve 50. The airtight chamber 52 is connected to a vacuum evacuation system 56 which includes a vacuum pump 54 for evacuating the airtight chamber 52, a pressure regulating valve 58 provided upstream of the pump 54, and a detoxifying device 60 provided downstream of the pump 54. The vacuum evacuation system 56 also includes a vacuum gauge 62 for measuring the pressure (vacuum) in the airtight chamber 52, and is designed to control the pressure regulating valve 58 based on an output from the vacuum gauge 62 so as to bring the pressure in the airtight chamber 52 to a predetermined pressure.

In the airtight chamber 52 is housed a substrate holder 64 for holding a substrate W with its front surface (surface to be processed) facing upwardly. The substrate holder 64 has, in its interior, a built-in heater for heating the substrate W held by the substrate holder 64 to a predetermined temperature. A lifting pin 70, which is vertically movable by a lifter 68 and penetrates a peripheral portion of the substrate holder 64, is provided in the airtight chamber 52. The airtight chamber 52 also houses a gas supply head 72, provided above the substrate holder 64, for jetting and supplying a gaseous carboxylic acid toward the substrate W held by the substrate holder 64.

Beside the airtight chamber 52 is disposed a carboxylic acid supply system 74 for continuously supplying a gaseous carboxylic acid by bubbling an inert gas, such as N₂ gas, into the carboxylic acid in the liquid state, according to this embodiment. The carboxylic acid supply system 74 includes a container 78 for storing a liquid carboxylic acid 76, an inert gas supply pipe 80 for supplying an inert gas into the liquid carboxylic acid 76 in the container 78 for bubbling of the inert gas, and a carboxylic acid supply pipe 82 for continuously supplying the carboxylic acid in the gaseous state which has collected in an upper space within the container 78. The carboxylic acid supply pipe 82 communicates with the gas supply head 72. The inert gas supply pipe 80 and the carboxylic acid supply pipe 82 are respectively provided with MFCs (mass flow controllers) 84a and 84b each for controlling the flow rate of the gas flowing in the pipe.

By supplying the inert gas from the inert gas supply pipe 80 into the container 78, the carboxylic acid, which has collected in the gaseous state in an upper space within the container 78, is supplied through the carboxylic acid supply pipe 82 to the gas supply head 72, and is supplied from the gas supply head 72 into the airtight chamber 52. The flow rate of the gaseous carboxylic acid supplied into the airtight chamber 52 is controlled by the MFCs 84a, 84b.

The carboxylic acid 76 is, for example, formic acid, acetic acid or propionic acid, or a mixture thereof. Such a carboxylic acid as formic acid, acetic acid or propionic acid is not only relatively inexpensive, but is also easy to handle because it is liquid at room temperature, and can react with a metal or an organic compound to thereby vaporize the metal or the organic compound. Accordingly, the use of a carboxylic acid, especially formic acid, acetic acid or propionic acid can remove a metal contaminant or an organic compound contaminant easily at a low cost, e.g. through volatilization, sublimation or decomposition.

Though in this embodiment a gaseous carboxylic acid is continuously supplied by bubbling of an inert gas, it is also possible to continuously supply a gaseous carboxylic acid by using a well-known method, such as vaporization by heating or vaporization depending on the atmosphere, the temperature and the pressure in an airtight container. The inert gas bubbling method is preferred because of no fear of explosion of gaseous carboxylic acid and corrosion of piping due to liquefaction of gaseous carboxylic acid in the piping. Further, instead of the MFCs, it is also possible to use shut-off valves or throttle valves.

The contaminant removal apparatus 44 of this embodiment also includes an inert gas introduction pipe 85, communicating with the gas supply head 72, for introducing an inert gas, such as N₂ gas, into the gas supply head 72. The inert gas introduction pipe 85 is provided with an MFC 84c for controlling the flow rate of the inert gas flowing in the pipe 85. By introducing the inert gas from the inert gas introduction pipe 84 into the gas supply head 72, it becomes possible to purge the interior of the gas supply head 72 and the airtight chamber 52, and to regulate the pressure in the airtight chamber 52.

It is preferred for safety that the gaseous carboxylic acid be kept at a concentration lower than the explosion limit, which is 18 vol % for formic acid, 4 vol % for acetic acid, and 2.9 vol % for propionic acid. Further, these carboxylic acids all have toxicity. Accordingly, the waste gas is detoxified in the detoxifying device 60 by, for example, scrubbing with water or an alkali, thermal decomposition or combustion before the waste gas is discharged.

The operation of the substrate processing apparatus will now be described. First, one substrate W is taken by the hand of the transport robot 46 out of the cassette housing substrates, which has been carried into the loading/unloading section 40. When the gate valve 50 of the airtight chamber 52 is open and the lifting pin 70 is in a raised position, the substrate W is carried by the hand of the transport robot 46 into the airtight chamber 52 and is supported on the lifting pin 70, and the hand is then withdrawn from the airtight chamber 52. Thereafter, the gate valve 50 is closed, and the lifting pin 70 is lowered so that the substrate W is held by the substrate holder 64.

Next, while heating the substrate W held by the substrate holder 64 by the heater so that the substrate W is kept at a temperature of not lower than 150° C., e.g. 200° C., and evacuating the airtight chamber 52 so that the internal pressure in airtight chamber 52 is kept at a predetermined pressure, e.g. about 400 Pa, a gaseous carboxylic acid, e.g. formic acid, is supplied from the gas supply head 72 into the airtight chamber 52 at a predetermined flow rate, e.g. about 30 sccm. By the above operation, a metal contaminant and/or an organic compound contaminant on the surface of the substrate W is heated and reacted with the carboxylic acid in an atmosphere containing the carboxylic acid, thereby removing the contaminant. When a contaminant on a low-k material is removed, the heating temperature of the substrate W is preferably not more than 300° C. so that the low-k material can endure the temperature.

For example, when Cu(OH)₂ or CuO as a metal (copper) contaminant is heated and reacted with formic acid (HCOOH) in an atmosphere containing formic acid, Cu(HCOO)₂ is produced and the Cu(HCOO)₂ vaporizes at the vapor pressure. By thus removing a contaminant, such as metal contaminant, from a substrate surface, leakage current between interconnects, for example, can be decreased. This holds also for an organic compound contaminant (organic complex) remaining on a substrate surface. Further, by carrying out the removal of a metal contaminant or an organic compound contaminant by a so-called dry method which involves no electrochemical corrosion, damage to interconnects, for example, can be reduced and the formation of an oxide film e.g. on the surface of the interconnects, due to insufficient drying of the substrate after cleaning, can be prevented.

The processing for the removal of a metal contaminant and/or an organic compound contaminant from the surface of the substrate W is carried out continuously for a predetermined time, for example, 10 minutes. After completion of the processing, the supply of the gaseous carboxylic acid (formic acid) into the airtight chamber 52 and the heating of the substrate W are stopped, and the pressure in the airtight chamber 52 is returned to atmospheric pressure. After raising the lifting pin 70 to thereby lift the substrate W up from the substrate holder 64, the gate valve 50 is opened and the hand of the transport robot 46 is inserted from the gate valve 50 into the airtight chamber 52. The hand of the transport robot 46 receives the substrate W from the lifting pin 70 and returns it to the cassette of the loading/unloading section 40.

In another exemplary method for the removal of a metal or organic contaminant from a substrate surface, nitrogen gas is supplied at a flow rate of 500 ml/min into acetic acid for bubbling at room temperature and atmospheric pressure to produce a nitrogen-diluted acetic acid gas having a concentration of about 1%, and the gas produced is supplied to a substrate W, held at 200° C. and atmospheric pressure in the airtight chamber 52, for 5 minutes.

FIG. 7 shows a substrate processing apparatus according to another embodiment of the present invention. This substrate processing apparatus adds the following construction to the substrate processing apparatus shown in FIG. 5: Two contaminant removal apparatuses 44 are provided in the interior of the apparatus frame 42. Furthermore, four polishing apparatuses 86, two cleaning apparatuses 88 e.g. of a roll or pencil brush type, two water-washing/drying apparatuses (spin driers) 90 and a second transport robot 92 for transferring a substrate W between them, are housed in the apparatus frame 42.

The four polishing apparatuses 86, according to this embodiment, are comprised of a pair of CMP apparatuses 86a designed to carry out chemical-mechanical polishing of a substrate surface at a low pressure of not more than 1 psi (about 70 hPa) so as not to cause damage to interconnects, and a pair of electrolytic polishing apparatuses 86b designed to press a polishing pad against a substrate surface in a polishing liquid not containing abrasive grains to flatten the substrate surface or to press a polishing pad against a substrate surface in a polishing liquid containing abrasive grains to flatten the substrate surface. After carrying out the removal of an interconnect material by the electrolytic polishing apparatus 86b, a barrier film is removed by the CMP apparatus 86a. It is also possible to use only one of a CMP apparatus and an electrolytic polishing apparatus for all the polishing apparatuses 86.

The water-washing/drying apparatus 90 may be omitted when the cleaning apparatus 88 has the function of water-washing (rinsing) a substrate surface e.g. with pure water and drying the substrate surface e.g. by spin-drying.

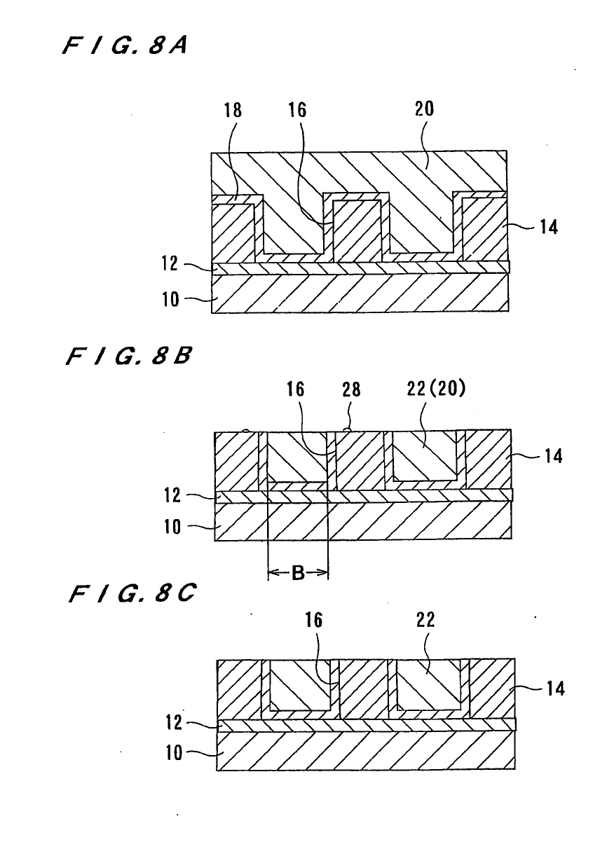

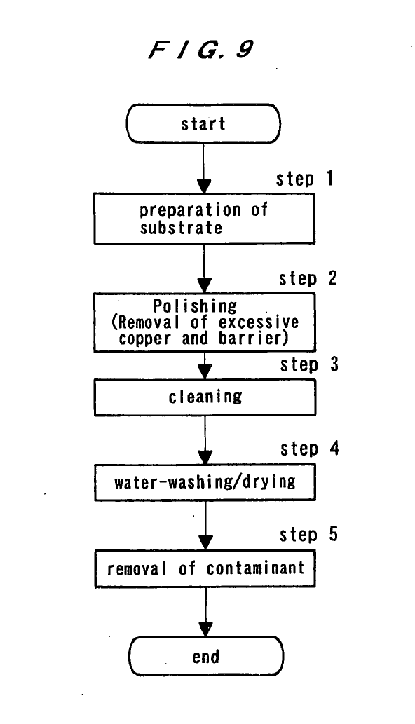

The operation of the substrate processing apparatus will now be described with reference to FIGS. 8 and 9. First, a substrate W, as shown in FIG. 8A, is provided, which has been prepared by forming an etch stopper film 12 on a surface of a lower-layer insulating film 10, depositing an upper-layer insulating film 14 on a surface of the etch stopper film 12, forming interconnect trenches 16 as interconnect recesses in the upper-layer . . . insulating film 14, forming a barrier film 18 on a surface of the upper-layer insulating film 14 and, as necessary, forming a seed layer (not shown), which serves as an electric supply layer for electroplating, on a surface of the barrier film 18, and carrying out copper plating of the substrate surface to fill the interconnect trenches 16 with copper and, at the same time, deposit a copper film 20 on the upper-layer insulating film 14 (step 1).

One substrate W is taken by the hand of the transport robot 46 out of a cassette housing substrates W, which has been carried into the loading/unloading section 40, and the substrate W is transferred to the second transport robot 92. The second transport robot 92 then transports the substrate W to the polishing apparatus 86. In the polishing apparatus 86, according to this embodiment, the copper film 20 on the upper-layer insulating film 14 is removed by the electrolytic polishing apparatus 86b, followed by removal of the barrier film 18 by the CMP apparatus 86a, thereby making the surface of the copper film 20 embedded in the interconnect trenches 16 substantially flush with the surface of the upper-layer insulating film 14 (step 2). Interconnects (copper interconnects) 22, composed of the copper film 20, are thus formed in the upper-layer insulating film 14, as shown in FIG. 8B.

The width B of the interconnects 22 is generally not more than 0.2 μm. The problem of current leakage between adjacent interconnects generally occurs when the width B of the interconnects 22 is not more than 2 μm. A low-k material is advantageously used for the insulating film (interlevel dielectric film) 14 when the width B of the interconnects 22 is not more than 0.1 μm, especially about 45 to 65 nm.

Besides copper used in this embodiment, silver, tungsten, tantalum, titanium, ruthenium, gold, tin or lead, or an alloy thereof may be used as an interconnect material.

Next, the substrate W after polishing is transported by the second transport robot 92 to the cleaning apparatus 88, where the surface of the substrate W is scrub-cleaned by rubbing the substrate surface with a brush having e.g. roll-shaped or pencil-shaped (step 3). The substrate W after the cleaning is transported to the water-washing/drying apparatus 90, where the substrate W is rinsed (water-washed) e.g. with pure water, followed by drying, such as spin-drying (step 4). Even after the scrub-cleaning of the surface of the substrate W, a residue 28 of copper after polishing can remain unremoved on the surface of the insulating film 14, as shown in FIG. 8B. Such a residue (copper) 28 is likely to cause current leakage between interconnects after the water-washing (rinsing) and drying, especially when the interconnects are fine and the insulating film 14 is formed of a low-k material. This holds true with the case where a residue of an organic complex between copper and an organic component of a liquid chemical remains on the surface of the substrate W.

The substrate W after water-washing and drying is then carried by the second transport robot 92 into the airtight chamber 52 of the contaminant removal apparatus 44, where processing may be carried out in the same manner as in the preceding embodiment. Thus, while keeping the temperature of the substrate W e.g. at 200° C. and the pressure in the airtight chamber 52 e.g. at about 400 Pa, gaseous formic acid is supplied into the airtight chamber 52 e.g. at a flow rate of about 30 sccm e.g. for 10 minutes, thereby removing a metal contaminant remaining on the surface of the insulating film 14, for example, the residue (copper) 28 which may be composed of Cu(OH)₂ or CuO, in the form of a vapor of Cu(HCOO)₂, the reaction product (salt) between the copper residue and formic acid, as shown in FIG. 8C (step 5). At the same time, an organic complex between copper and an organic component of a liquid chemical, remaining on the surface of the substrate W, is removed.

It has been confirmed experimentally that when a substrate with interconnects, having an interconnect width of 0.16 μm and an interconnect spacing of 0.16 μm, formed in an insulating film in the surface, is provided and a metal contaminant on the insulating film is removed in an atmosphere containing formic acid as the carboxylic acid, leakage current upon 2V application can be decreased to about one-tenth as compared to the case of removing the metal contaminant only by pure water-washing as conventionally practiced. In the experiment, the leakage current was determined by two-point probe measurement.

Further, by employing a so-called dry method which involves no electrochemical corrosion, it becomes possible to considerably reduce damage to interconnects, to prevent the formation of an oxide film e.g. on the surfaces of interconnects due to insufficient drying of the substrate after cleaning, and to reduce the amount of chemical used.

The substrate W after the removal of a metal contaminant on the insulating film and an organic compound contaminant on the substrate is taken by the transport robot 46 out of the airtight chamber 52 of the contaminant removal apparatus 44 and returned to the cassette of the loading/unloading section 40.

FIG. 10 shows a substrate processing apparatus according to yet another embodiment of the present invention. This substrate processing apparatus adds the following construction to the substrate processing apparatus shown in FIG. 5: Two contaminant removal apparatuses 44 are provided in the interior of the apparatus frame 42. Furthermore, pairs of pre-cleaning apparatuses 94, pre-processing apparatuses 96, electroless plating apparatuses 98 and water-washing/drying apparatuses (spin driers) 90, and a second transport robot 92 for transferring a substrate W between them, are housed in the apparatus frame 42.

This embodiment employs the electroless plating apparatus 98 as a protective film-forming apparatus, and carries out attendant processings by the pre-cleaning apparatus 94 and the pre-processing apparatus 96.

The water-washing/drying apparatus 90 may be omitted when the pre-cleaning apparatus 94, the pre-processing apparatus 96 and the electroless plating apparatus 98 have the function of water-washing a surface of a substrate with e.g. pure water and drying the substrate e.g. by spin-drying.

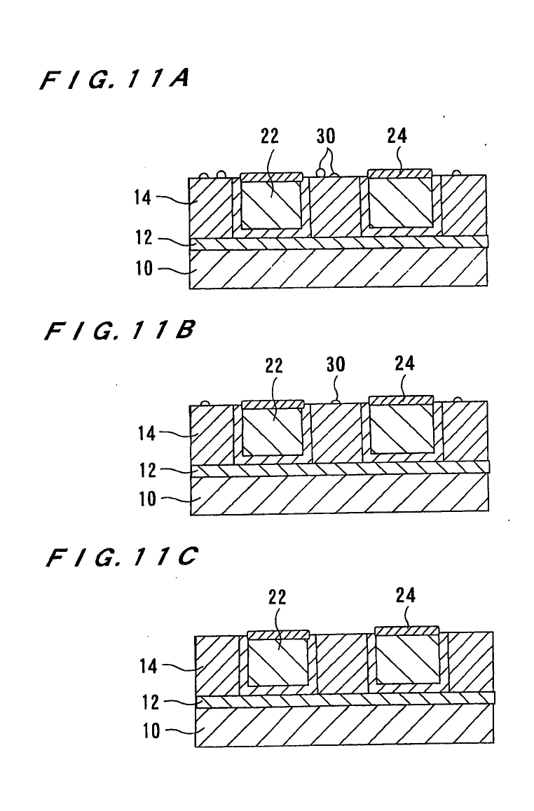

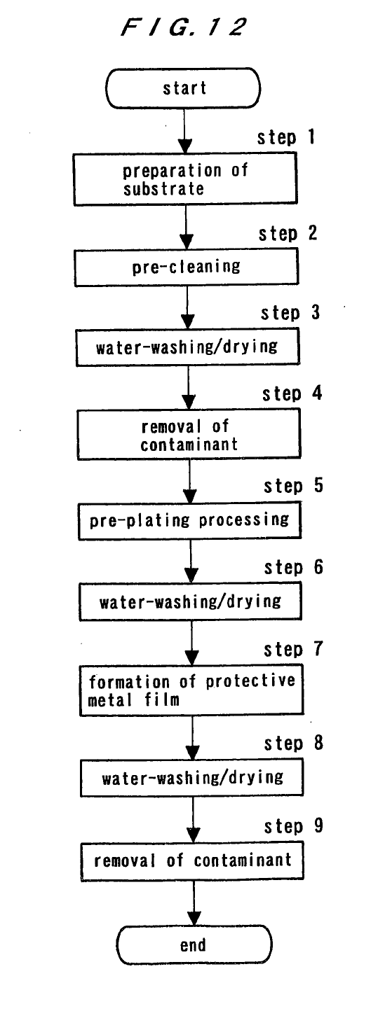

The operation of this substrate processing apparatus will now be described with reference to FIGS. 11 and 12. First, a substrate W as shown in FIG. 8C, having interconnects (copper interconnects) 22 formed in an upper-layer insulating film 14, is provided (step 1).

One substrate W is taken by the hand of the transport robot 46 out of a cassette housing such substrates W, which has been carried into the loading/unloading section 40, and the substrate W is transferred to the second transport robot 92. The second transport robot 92 transports the substrate W to the pre-cleaning apparatus 94. In the pre-cleaning apparatus 94, pre-cleaning of the substrate W is carried out by jetting a cleaning solution, such as dilute H₂HO₄ at 25° C. toward the surface of the substrate W to remove CMP residues, such as copper, remaining on the surface of the insulating film 14 and an oxide film on the interconnects 22 (step 2). The substrate W after the pre-cleaning is transported to the water-washing/drying apparatus 90, where the substrate W is rinsed (water-washed), followed by drying; such as spin-drying (step 3).

The substrate W after drying is carried by the second transport robot 92 into the airtight chamber 52 of the contaminant removal apparatus 44, where a metal contaminant on the surface of the insulating film 14 and/or an organic compound contaminant on the substrate surface is heated and reacted with a gaseous carboxylic acid, such as formic acid, in the same manner as described above, thereby removing the metal or organic compound contaminant in the form of a vapor of a metal carboxylate or a vapor of a carboxylic acid compound (step 4). The substrate W after the removal of such contaminants is transported by the second transport robot 92 to the pre-processing apparatus 96.

In the pre-processing apparatus 96, pre-processing of the substrate W is carried out by bringing the surface of the substrate W into contact with e.g. a solution of palladium sulfate e.g. at 25° C. to apply Pd as a catalyst to the surface of the interconnects 22 (step 5). The substrate W after the pre-plating processing is transported to the water-washing/drying apparatus 90, where the substrate W is rinsed (water-washed) with e.g. pure water, followed by drying, such as spin-drying (step 6). The substrate W after water-washing and drying is transported by the second transport robot 92 to the electroless plating apparatus 98.

In the electroless plating apparatus 98, the surface of the substrate W is brought into contact with an electroless plating solution to form a protective metal film 24 of e.g. a CoWP alloy, which grows with Pd as a seed, selectively on surfaces of interconnects 22 to protect the interconnects 22, as shown in FIG. 11A (step 7). A thickness of the protective metal film 24 is, for example, about 10 nm.

The protective metal film 24 may be composed of, for example, cobalt, nickel, tungsten, vanadium or molybdenum, or an alloy or a compound thereof. A Co alloy such as a CoWP alloy or a Ni alloy such as a NiWP alloy, which has high adhesion to an interconnect material such as copper and a low resistivity (ρ), is generally used for the protective metal film 24.

The substrate W after the formation of the protective metal film 24 is transported to the water-washing/drying apparatus 90, where the substrate W is rinsed (water-washed) with e.g. pure water, followed by drying, such as spin-drying (step 8). Even after the water-washing of the surface of the substrate W, a CoWP alloy or the like can remain as a residue 30 on the surface of the insulating film 14, as shown in FIG. 11B. Further, with a Pd residue remaining unremoved on the insulating film 14 as a seed, a CoWP alloy deposits on the insulating film 14 and becomes a residue 30. An organic complex can also remain as a residue on the surface of the substrate W.

The substrate W after water-washing and drying is carried by the second transport robot 92 into the airtight chamber 52 of the contaminant removal apparatus 44, where a metal contaminant on the surface of the insulating film 14 and/or an organic complex contaminant on the substrate surface is heated and reacted with a gaseous carboxylic acid, such as formic acid, in the same manner as described above, thereby removing the metal or organic contaminant in the form of a vapor of a metal carboxylate or a vapor of carboxylic acid compound (step 9).

According to this embodiment, the removal of a metal contaminant and/or an organic compound contaminant is carried out before applying Pd as a catalyst seed to the surface of the interconnects 22 so as to prevent Pd from adhering to a CMP residue remaining on the insulating film or to an organic compound contaminant remaining on the substrate, thereby preventing a CoWP alloy from depositing on the insulating film or the substrate surface with the Pd as a seed and causing an increase in leakage current. The removal of a metal or organic component contaminant before Pd application, however, can decrease the volume of interconnects 22 and thus increase the resistance of interconnects 22. Accordingly, in case the problem of the rise in the resistance of interconnects 22 due to the decrease in the volume of the interconnects 22 is involved, it is preferred not to carry out the removal of a metal or organic compound contaminant before applying Pd as a catalyst seed to the surface of the interconnects 22. On the other hand, the removal of a metal or organic compound contaminant after application of Pd as a catalyst seed to the surface of interconnects 22, because of deactivation of the catalyst and the attendant lowering of reactivity, does not cause such a problem.

By thus carrying out the removal of a metal contaminant and/or an organic compound contaminant from a substrate surface not in a solution, but in the airtight chamber 52, it becomes possible to prevent an increase in leakage current and a rise in the resistance of interconnects, to eliminate cleaning and drying of the substrate after the removal of the contaminant, and to prevent oxidation of the surface of the protective metal film 24.

It has been confirmed experimentally that when a substrate surface having interconnects formed in the surface is exposed to a vapor of formic acid for about 10 minutes under the processing conditions of a processing temperature of 200° C., a processing pressure of about 400 Pa and a gas flow rate of about 30 sccm, leakage current between interconnects can be decreased to about one-tenth and a rise in the resistance of the interconnects can be reduced by 10% as compared to the case of removing the contaminant only by pure water-washing as conventionally practiced. The leakage current and the resistance of interconnects were determined by two-point probe measurement. Further, external observation under a scanning electron microscope (SEM) reveled no residue, deterioration, etc. between interconnects.

Similar results were obtained when nitrogen gas was supplied at a flow rate of 500 ml/min into acetic acid for bubbling at room temperature and atmospheric pressure to produce a nitrogen-diluted acetic acid gas having a concentration of about 1%, and the gas produced was supplied to a substrate, held at 200° C. and atmospheric pressure in a processing chamber, for 5 minutes.

The substrate W after the removal of a metal contaminant on the insulating film and/or an organic compound contaminant on the substrate is taken by the transport robot 46 out of the airtight chamber 52 of the contaminant removal apparatus 44 and is returned to the cassette of the loading/unloading section 40.

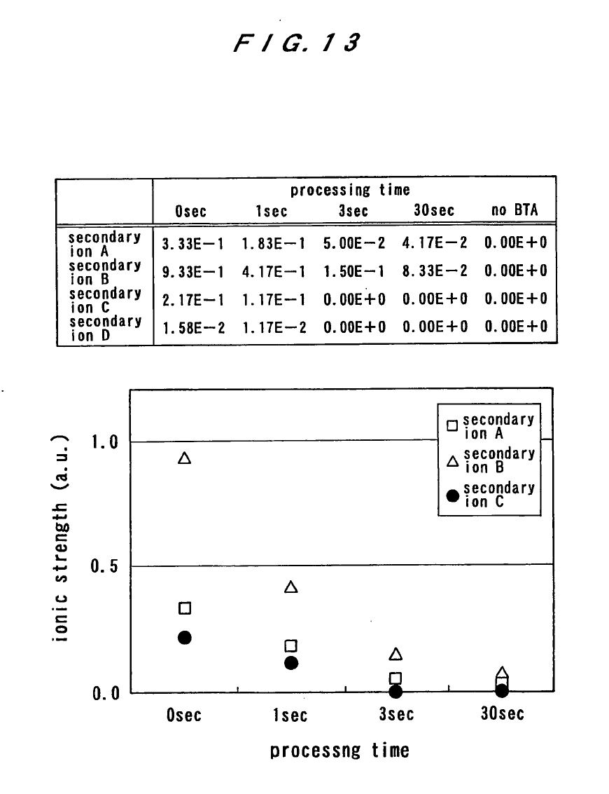

FIG. 13 shows the results of an experimental removal processing for the removal of BTA (benzotriazole) which is a persistent organic compound and is used as an anticorrosive component in a polishing chemical for use in CMP. In the experiment, a substrate after having been immersed in a solution containing BTA was exposed to formic acid gas under the conditions of: processing temperature of 200° C.; processing pressure of about 400 Pa; and gas flow rate of about 400 sccm. The intensities of particular secondary ions, secondary ions A, B and C deriving from BTA, were measured by TOF-SIMS (Time of Flight-Secondary Ion Mass Spectrometry) for the substrate after 1, 3 and 30 seconds from the start of its exposure to the formic acid gas, the results of which are shown in FIG. 13.

As apparent from the data in FIG. 13, the amount of BTA on the substrate gradually decreases with the processing time, and the BTA on the substrate can be substantially removed by exposing the substrate to formic acid gas for about 30 seconds.

After the formation of interconnect trenches 16 as interconnect recesses in an upper-layer insulating film 14 deposited on an etch stopper film 12 formed on a lower-layer insulating film 10, as shown in FIG. 8A, it is possible to remove a resist, which has become unnecessary, for example, by chemical cleaning or ashing while leaving a resist residue, and heat and react the remaining resist residue with a carboxylic acid in an atmosphere containing the carboxylic acid by the contaminant removal apparatus 44 shown in FIG. 6, thereby removing the resist residue.

This can prevent moisture from entering the insulating film of e.g. a low-k material and increasing the risk of current leakage, or can prevent damage, such as corrosion, to interconnects or to the insulating film.

### INDUSTRIAL APPLICABILITY

The present invention is applicable to substrate processing method and apparatus for cleaning a surface of a substrate such as a semiconductor wafer, for example, in the production of a semiconductor device.

1. A substrate processing method, comprising:
heating and reacting an organic compound contaminant on a substrate with a carboxylic acid in an atmosphere containing the carboxylic acid, thereby removing the organic compound contaminant.

2. A substrate processing method, comprising:
providing a substrate which has been prepared by forming a barrier film on a surface of a substrate having interconnect recesses formed in an insulating film, and forming a film of an interconnect material on a surface of the barrier film while filling the interconnect recesses with the interconnect material;
removing an extra interconnect material and an extra barrier film from the surface of the substrate to thereby form interconnects composed of the interconnect material embedded in the interconnect recesses; and
heating and reacting an organic compound contaminant on the substrate with a carboxylic acid in an atmosphere containing the carboxylic acid, thereby removing the organic compound contaminant.

3. A substrate processing method, comprising:
providing a substrate having interconnects formed of an interconnect material embedded in interconnect recesses provided in an insulating film;
forming a protective metal film selectively on surfaces of interconnects; and
heating and reacting an organic compound contaminant on the substrate with a carboxylic acid in an atmosphere containing the carboxylic acid, thereby removing the organic compound contaminant.

4-5. (canceled)

6. The substrate processing method according to claim 1, wherein the organic compound contaminant is a resist residue remaining on the surface of the substrate after the removal of a resist.

7. The substrate processing method according to claim 2, wherein the removal of the interconnect material and the barrier film is carried out by CMP, electrolytic polishing or a combination thereof.

8. The substrate processing method according to claim 3, wherein the formation of the protective metal film is carried out by electroless plating.

9. The substrate processing method according to claim 3, wherein the protective metal film is composed of cobalt, nickel, tungsten, vanadium or molybdenum, or an alloy or a compound thereof.

10. The substrate processing method according to claim 2, wherein the interconnects include interconnects having an interconnect width of not more than 0.2 μm.

11. The substrate processing method according to claim 2, wherein the interconnect material is copper, silver, tungsten, tantalum, titanium, ruthenium, gold, tin or lead, or an alloy thereof.

12. The substrate processing method according to claim 1, wherein the surface of the substrate is water-washed prior to the removal of the organic compound contaminant on the substrate.

13. The substrate processing method according to claim 1, wherein the carboxylic acid is formic acid, acetic acid or propionic acid, or a mixture thereof.

14. The substrate processing method according to claim 2, wherein the insulating film is composed of SiO₂, a low-k material or a porous low-k material.

15. A substrate processing apparatus, comprising:
a contaminant removal apparatus for heating and reacting an organic compound contaminant on a substrate with a carboxylic acid in an atmosphere containing the carboxylic acid, thereby removing the organic compound contaminant.

16-17. (canceled)

18. The substrate processing apparatus according to claim 15, wherein the organic compound contaminant is a resist residue remaining on the surface of the substrate after the removal of a resist.

19. The substrate processing apparatus according to claim 15, wherein the contaminant removal apparatus includes:
an airtight chamber capable of vacuum evacuation, housing a substrate holder for holding a substrate and heating the substrate, and a gas supply head for supplying a gaseous carboxylic acid to the substrate held by the substrate holder; and
a carboxylic acid supply system for supplying the gaseous carboxylic acid to the gas supply head.

20. The substrate processing apparatus according to claim 15, further comprising a water-washing/drying apparatus for water-washing and drying the surface of the substrate.

21. The substrate processing apparatus according to claim 15, further comprising a polishing apparatus for polishing away an extra interconnect material and an extra barrier film from the surface of the substrate.

22. The substrate processing apparatus according to claim 15, further comprising a protective film-forming apparatus for forming a protective metal film selectively on surfaces of interconnects formed of an interconnect material embedded in interconnect recesses provided in an insulating film in the surface of the substrate.
